(19) United States
(12) Patent Application Publication
(10) Pub. No.: US 2025/0347374 A1
(43) Pub. Date: Nov. 13, 2025

(54) FLUID COUPLINGS

(71) Applicant: Colder Products Company, Roseville, MN (US)

(72) Inventors: Maria Frances Bollensen, Minnetonka, MN (US); David A. Burdge, Richfield, MN (US); Paul G. Burleigh, Woodbury, MN (US); Neal W. Feldhahn, Oak Park Heights, MN (US); Boris Rubanovich, Oak Grove, MN (US); Loi T. Truong, Savage, MN (US); Michael T. Wingert, Buffalo, MN (US)

(21) Appl. No.: 19/201,206

(22) Filed: May 7, 2025

Related U.S. Application Data
(60) Provisional application No. 63/644,178, filed on May 8, 2024.

(51) Int. Cl. F16L 37/127

(52) U.S. Cl. CPC F16L 37/127

(57) ABSTRACT

Fluid coupling systems can include a latching mechanism to releasably latch together two fluid handling devices in an operative arrangement. Such latching mechanisms can include collet connection mechanisms. For example, this document describes fluid couplings with collet connection mechanisms that are adapted to couple with a fluid fitting of a mated fluid coupling quickly and conveniently. Such fluid fittings can include, but are not limited to, a barbed fitting or a sanitary fitting.

### CROSS-REFERENCE TO RELATED APPLICATIONS

This application claims the benefit of U.S. Provisional Application Ser. No. 63/644,178 filed May 8, 2024. The disclosure of the prior application is considered part of (and is incorporated by reference in) the disclosure of this application.

### BACKGROUND

### 1. Technical Field

This document relates to fluid couplings with collet connection mechanisms.

### 2. Background Information

In typical fluid couplings, various types of quick latching mechanisms have been utilized. For example, some types of fluid couplings use a collar and ball lock or a ball-in-groove latching mechanism. Other types of fluid couplings use a thumb-latch style of latching mechanism that includes a tongue in groove arrangement. Still others include a separate clamp device that is used to connect sanitary fittings, and a hose clamp used to secure a tube on a barbed fitting.

### SUMMARY

This document describes fluid couplings with collet connection mechanisms. For example, this document describes fluid couplings with collet connection mechanisms that are adapted to couple with a fluid fitting quickly and conveniently. Such fluid fittings can include, but are not limited to, a barbed fitting, a threaded fitting, a compression fitting, or a sanitary fitting.

In one aspect, this disclosure is directed to a fluid coupling device that includes a main body, a collet, and a collar. In some embodiments, the main body defines a fluid passageway extending along a longitudinal axis between a first end and a second end. In some embodiments, the main body has a blank end and no fluid passageway. The collet includes a plurality of arcuate segments. A front-end portion of the collet surrounds the second end of the main body and defines an open internal area shaped to receive a termination of a fluid handling component to be mated with the second end of the main body. Each arcuate segment is pivotable in relation to the main body to reconfigure the collet between: (i) a closed configuration in which the front-end portion of the collet is arranged to clamp onto the termination of the fluid handling component mated with the second end of the main body and (ii) an open configuration in which the front-end portion of the collet is radially expanded in comparison to the closed configuration. The collar surrounds the main body and at least a portion of the collet. The collar is longitudinally slidable along the main body between a first position that allows the collet to be in the open configuration and a second position that forces the collet to be in the closed configuration.

Such a fluid coupling device may optionally include one or more of the following features. In some embodiments, a rear-end portion of the collet radially contracts when the collet reconfigures from the closed configuration to the open configuration. A midbody portion of the collet may be in contact with a fulcrum about which each arcuate segment is pivotable. The main body may include the fulcrum, or the fulcrum may be coupled to the main body. The fluid coupling device may also include a garter spring or an elastic member surrounding a rear-end portion of the collet. In some embodiments, the open internal area shaped to receive the termination of the fluid handling component is shaped to receive a barbed end fitting. The fluid coupling device may also include an annular seal member arranged in an annular groove defined by the main body at a location in which the annular seal member will seal against an inner diameter of a barbed end fitting. The open internal area may be shaped to receive a sanitary end fitting or a threaded fitting. The fluid collet may also include one or more living hinges. Each living hinge may interconnect two adjacent arcuate segments of the plurality of arcuate segments. In some embodiments, the collar comprises two identical half portions that are configured to snap together to form the collar. The collar may define a plurality of longitudinally extending grooves in which longitudinally extending protrusions of the plurality of arcuate segments are slidably disposed.

In another aspect, this disclosure is directed to a fluid coupling device that includes: (i) a main body defining a fluid passageway extending along a longitudinal axis between a first end and a second end; (ii) a collet comprising a plurality of arcuate segments; and (iii) a collar surrounding the main body and at least a portion of the collet. The collar can be longitudinally slidable along the main body between: (i) a first position that allows the collet to radially expand to an open configuration to receive a termination of a fluid handling device to be mated with the second end of the main body and (ii) a second position that forces the collet to a closed configuration in which the collet clamps onto the termination of the fluid handling device to be mated with the second end of the main body.

Such a fluid coupling device may optionally include one or more of the following features. The collet may define an open internal area shaped to receive the termination of the fluid handling component to be mated with the second end of the main body. The open internal area shaped to receive the termination of the fluid handling device may be shaped to receive a barbed end fitting. The open internal area shaped to receive the termination of the fluid handling device may be shaped to receive a sanitary end fitting or a threaded fitting. In some embodiments, a midbody portion of each arcuate segment is pivotable in relation to the main body about a fulcrum to reconfigure the collet between the open configuration and the closed configuration. The main body may include the fulcrum, or the fulcrum may be coupled to the main body. In some embodiments, each arcuate segment is uncoupled from any other arcuate segment. Some embodiments of the fluid coupling device may also include a garter spring or an elastic member surrounding a rear-end portion of the collet. The collar may define a plurality of longitudinally extending grooves in which longitudinally extending protrusions of the plurality of arcuate segments are slidably disposed. The collet may define a plurality of longitudinally extending grooves in which longitudinally extending protrusions of the collar are slidably disposed. In some embodiments, the collar is configured to contact rear ends of the arcuate segments to radially expand the collet to the open configuration when the collar is in the first position. The collet and the collar may be positioned at the first end of the main body, and the fluid coupling device may include a second collet and a second collar positioned at the second end of the main body. The fluid coupling device may also include a first two-piece retaining collar on the main body and positioned to define the first position of the collar; and a second two-piece retaining collar on the main body and positioned to define a first position of the second collar. In some embodiments, the first end of the main body includes a blank end arranged to block fluid flow through the fluid coupling device.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description herein. Other features, objects, and advantages of the invention will be apparent from the description and drawings, and from the claims.

### DESCRIPTION OF THE DRAWINGS

FIGS. 1-3 show various views of an example fluid coupling that includes a collet connection mechanism in an open configuration in accordance with some embodiments.

FIGS. 4-6 show various longitudinal cross-sectional views of the fluid coupling in accordance with FIG. 3.

FIGS. 7-9 show various views of the fluid coupling of FIGS. 1-3 in a closed configuration.

FIGS. 10-12 show various longitudinal cross-sectional views of the fluid coupling in accordance with FIG. 9.

FIGS. 13-15 show various views of a main body of the fluid coupling of FIGS. 1-3.

FIG. 16 shows a longitudinal cross-sectional view of the main body in accordance with FIG. 15.

FIGS. 17-19 show various views of a collet of the fluid coupling of FIGS. 1-3.

FIGS. 20 and 21 show various longitudinal cross-sectional views of the collet in accordance with FIG. 19.

FIGS. 22-24 show various views of a fulcrum member of the fluid coupling of FIGS. 1-3.

FIG. 25 shows a transverse cross-sectional view of the fulcrum member in accordance with FIG. 24.

FIGS. 26-28 show various views of a collar of the fluid coupling of FIGS. 1-3.

FIG. 29 shows a transverse cross-sectional view of the collar in accordance with FIG. 28.

FIGS. 30-32 show various views of another example fluid coupling that includes a collet connection mechanism in an open configuration in accordance with some embodiments.

FIGS. 33 and 34 show various longitudinal cross-sectional views of the fluid coupling in accordance with FIG. 32.

FIGS. 35-37 show various views of the fluid coupling of FIGS. 30-32 in a closed configuration.

FIGS. 38 and 39 show various longitudinal cross-sectional views of the fluid coupling in accordance with FIG. 37.

FIGS. 40-42 show various views of a main body of the fluid coupling of FIGS. 30-32.

FIG. 43 shows a longitudinal cross-sectional view of the main body in accordance with FIG. 42.

FIGS. 44-46 show various views of a collet of the fluid coupling of FIGS. 30-32.

FIG. 47 shows a longitudinal cross-sectional view of the collet in accordance with FIG. 46.

FIGS. 48-50 show various views of a collar of the fluid coupling of FIGS. 30-32.

FIG. 51 shows a longitudinal cross-sectional view of the collar in accordance with FIG. 50.

FIG. 52 shows a perspective view of a union coupling that includes collet connection mechanisms as described herein.

FIG. 53 shows a longitudinal cross-sectional view of the union coupling of FIG. 52.

FIG. 54 shows a perspective view of a cap coupling that includes a collet connection mechanism as described herein.

FIG. 55 shows a longitudinal cross-sectional view of the cap coupling of FIG. 54.

Like reference numbers represent corresponding parts throughout.

### DETAILED DESCRIPTION

This document describes fluid couplings with collet connection mechanisms. For example, this document describes fluid couplings with collet connection mechanisms that are adapted to couple with a fluid fitting quickly and conveniently. Such fluid fittings can include, but are not limited to, a barbed fitting, a threaded fitting, or a sanitary fitting.

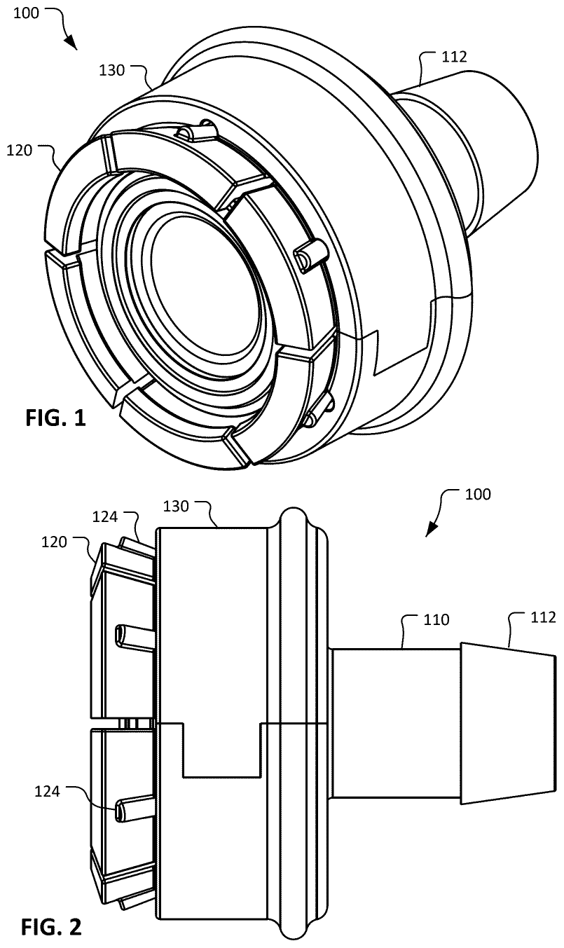

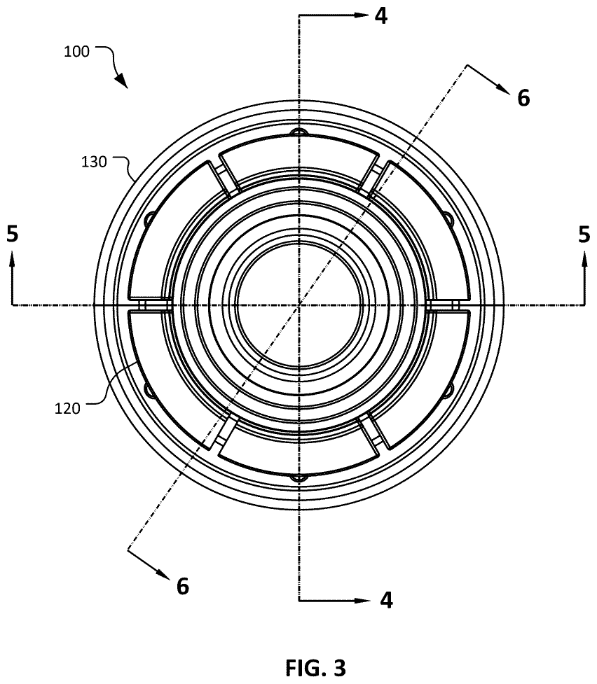

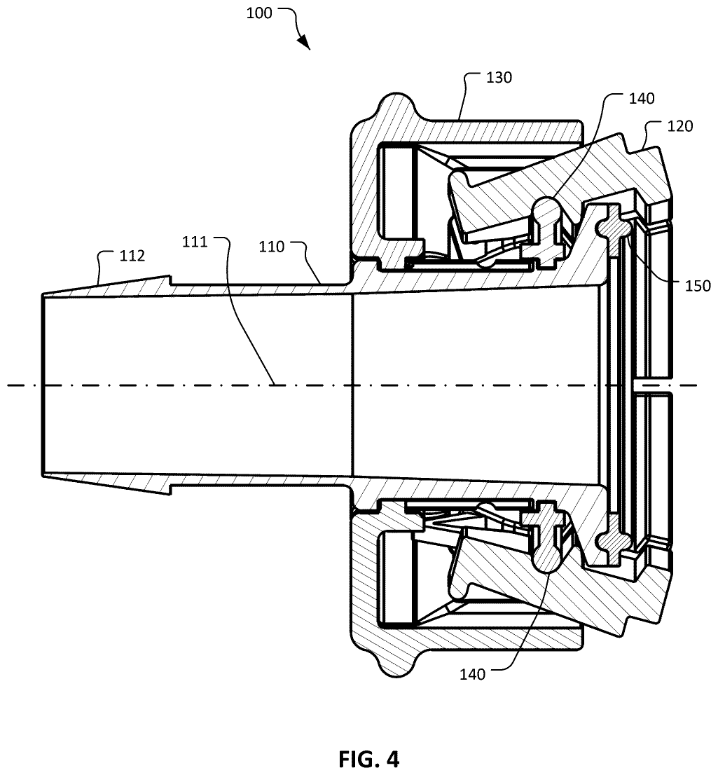

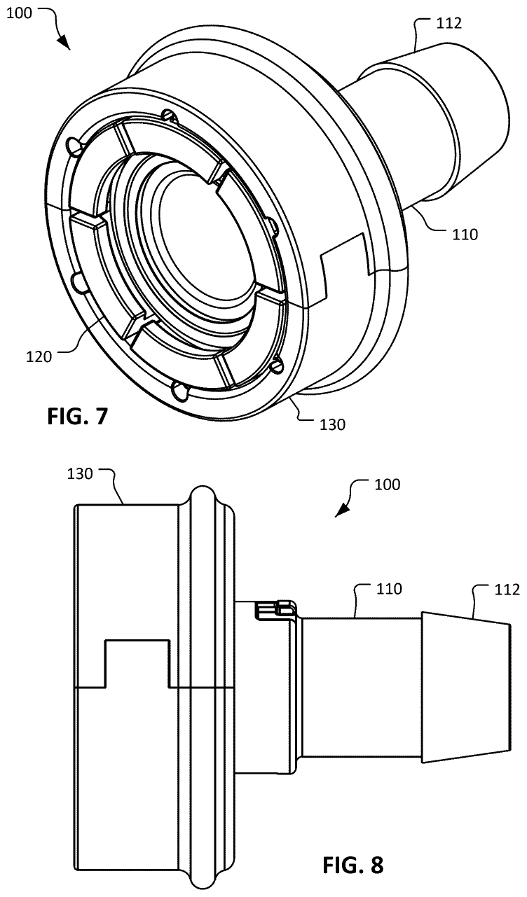

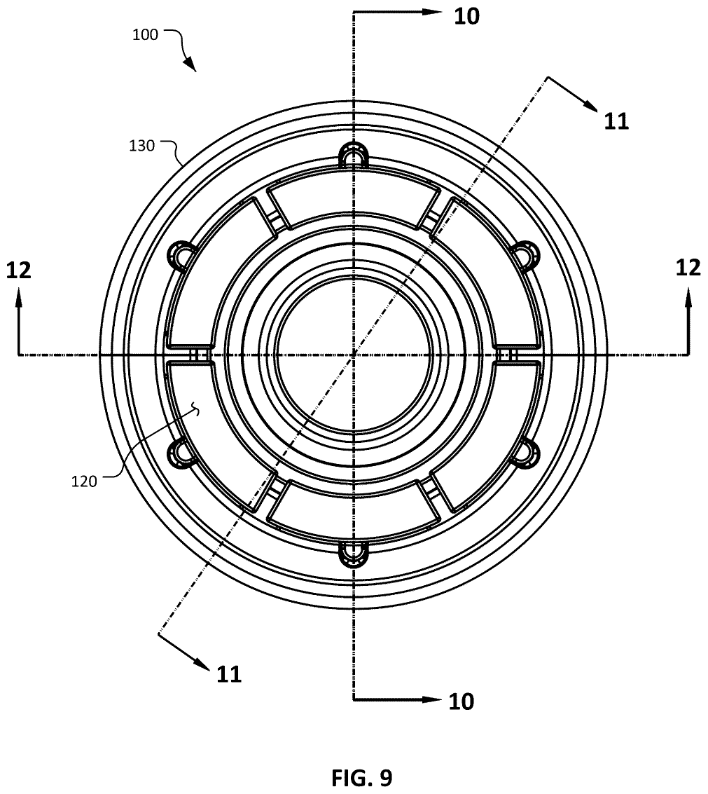

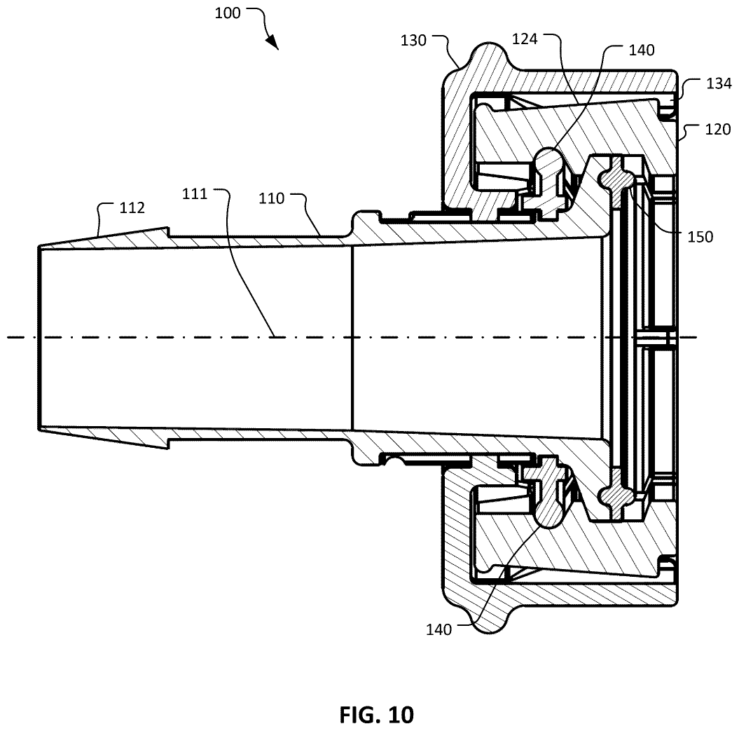

Referring to FIGS. 1-12, an example fluid coupling device 100 (or simply “fluid coupling 100”) includes a main body 110 with a termination 112, a collet 120, a collar 130, a fulcrum member 140, and a seal member 150. The collet 120 is reconfigurable between an open configuration (as shown in FIGS. 1-6) and a closed configuration (as shown in FIGS. 7-12). The collar 130 is longitudinally slidable along the main body to reconfigure the collet 120 between the open and closed configurations.

The collet 120 defines an internal space that is configured to receive (when open) and clamp onto (when closed) a termination of a fluid coupling to be mated to the fluid coupling 100. In the depicted embodiment, the internal space of the collet 120 is sized and shaped to receive and clamp onto a sanitary fitting of a fluid connector to be mated to the fluid coupling 100. The seal member 150 is a typical type of gasket or seal that is used between the flanges of two sanitary fittings.

A user can couple or mate the fluid coupling 100 with a sanitary fitting of another fluid handling device by simply: (i) placing the sanitary fitting against the seal member 150 when the collet 120 is in the open configuration and (ii) sliding the collar 130 over the collet 120 to reconfigure the collet 120 to the closed configuration. The collet 120 thereby clamps the sanitary fitting of the mated fluid handling device to the fluid coupling 100 in a liquid-tight and mechanically robust connection. To uncouple the fluid coupling 100 and the mated fluid handling device, the user can simply slide the collar 130 at least partially off the collet 120 (i.e., by sliding the collar 130 toward the termination 112) so that the collet 120 reconfigures to the open configuration in which the sanitary fitting of the mated fluid handling device is released from its previous clamped condition.

The main body 110 defines a fluid passageway extending along a central longitudinal axis 111. The main body 110 includes the termination 112 at a first end portion of the main body 110. While the termination 112 is depicted as a barbed connection, it should be understood that the fluid coupling 100 (and other fluid couplings described herein) can have any type of termination or connection such as, but not limited to, a barbed fitting, a threaded connection (e.g., straight thread or pipe thread), a sanitary fitting, a compression fitting, an aseptic connection, a quick connect, a quick disconnect, a hydraulic connection, a luer fitting, a solder connection, a welded connection, and the like, and combinations thereof. Such connections can be straight (as depicted) or in another arrangement such as, but not limited to, a 90° elbow arrangement, a 45° elbow, a straight fitting, a Tee fitting, a Y-fitting, and so on. In some embodiments, the fluid coupling 100 can be configured to be fluidly coupled with a fluid conduit such as, but not limited to, a tube, pipe, a manifold, and the like, without limitation.

The materials from which one or more of the components of the fluid coupling 100 (and other fluid couplings described herein) are made of include thermoplastics or thermosets. In particular embodiments, the materials from which the components of the fluid coupling 100 are made of are thermoplastics, such as, but not limited to, acetal, ABS, polycarbonate, polysulfone, polyether ether ketone, polysulphide, polyester, polyvinylidene fluoride (PVDF), polyethylene, Perfluoropolymers (PFA, PTFE, PCTFE and the like), polyphenylsulfone (PPSU; e.g., Radel®), polyetherimide (PEI; e.g., Ultem®), polypropylene, polyphenylene, polyaryletherketone, Perfluoropolymers (PFA, PTFE, PCTFE and the like) and the like, and combinations thereof. In some embodiments, the thermoplastics can include one or more fillers such as, but not limited to, glass fiber, glass bead, carbon fiber, talc, etc.

In some embodiments, the materials from which one or more of the components of the fluid coupling 100 (and other fluid couplings described herein) are made of include metals such as, but not limited to stainless steel, brass, aluminum, plated steel, zinc, and the like. In particular embodiments, the fluid coupling 100 is metallic-free.

In some embodiments, the fluid coupling 100 (and other fluid couplings described herein) includes one or more plastic (e.g., PEEK, PPS, etc.) or metallic spring members (e.g., spring steel, stainless steel such as 316L, piano/music wire, beryllium copper, titanium, Hastelloy®, Inconel®, and the like).

In certain embodiments, the fluid coupling 100 (and other fluid couplings described herein) includes one or more gaskets or seals (e.g., the seal member 150) made of materials such as, but not limited to, silicone, fluoroelastomers (FKM), ethylene propylene diene monomer (EPDM), perfluoroelastomers (e.g., FFKM, Kalrez®, Chemraz® and the like), thermoplastic elastomers (TPE), buna, buna-N, thermoplastic vulcanizates (TPV), and the like. In some embodiments, the gaskets or seals can have a cross-sectional shape that is an hourglass-shape, an oval shape, a circular shape, D-shaped, X-shaped, square, rectangular, U-shaped, L-shaped, V-shaped, a polygonal shape, a multi-lobe shape, or any other suitable shape, without limitation.

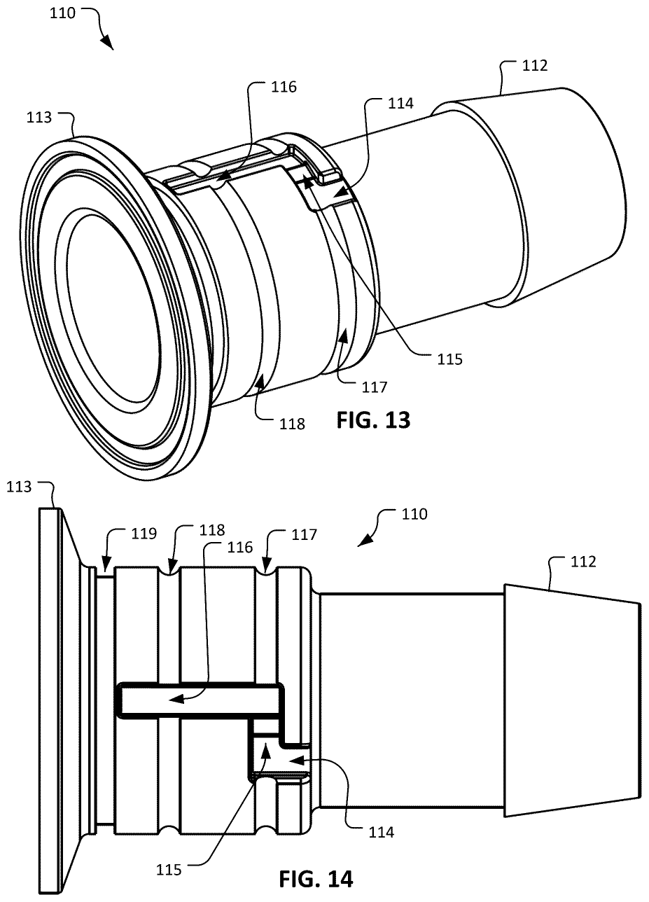

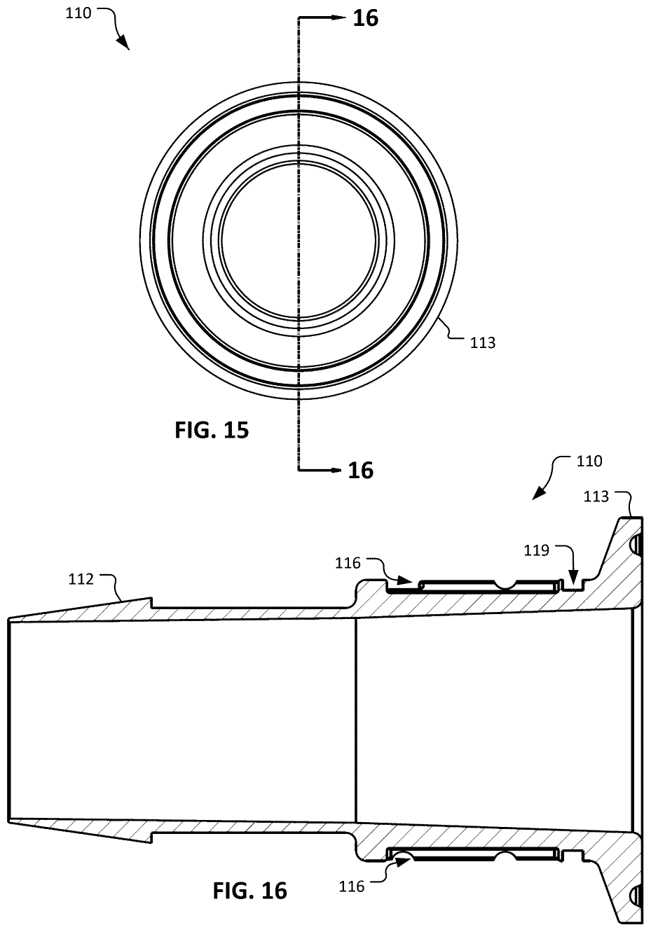

In FIGS. 13-16, the main body 110 is shown in isolation so that its features are more clearly visible. The main body 110 includes a sanitary fitting 113 at a second end portion of the main body 110 (wherein the second end portion is at an opposite end of the main body 110 in comparison to the termination 112 located at the first end portion of the main body 110). In some embodiments, other types of fittings are located at the second end portion of the main body 110.

While the depicted termination 112 (i.e., the barbed fitting) has a relatively small outer diameter in comparison to other portions of the main body 110, in some embodiments the type or design of termination 112 will have a larger outer diameter than the depicted barbed fitting. For example, in some embodiments the termination 112 may be a sanitary fitting, or another type of fitting, that is similar in size to the sanitary fitting 113. In such a case, the large outer diameter of the termination 112 will prevent the collet 120, the collar 130, and/or the fulcrum member 140 from being longitudinally moved over the termination 112 and into position on the mid-body area of the main body 110 between the termination 112 and the sanitary fitting 113 during assembly of the fluid coupling 100. For that reason, in the depicted embodiment the collet 120, the collar 130, and the fulcrum member 140 are each two-piece components that can be assembled directly on the mid-body area of the main body 110 (rather than being longitudinally moved over the termination 112 into position on the mid-body area of the main body 110).

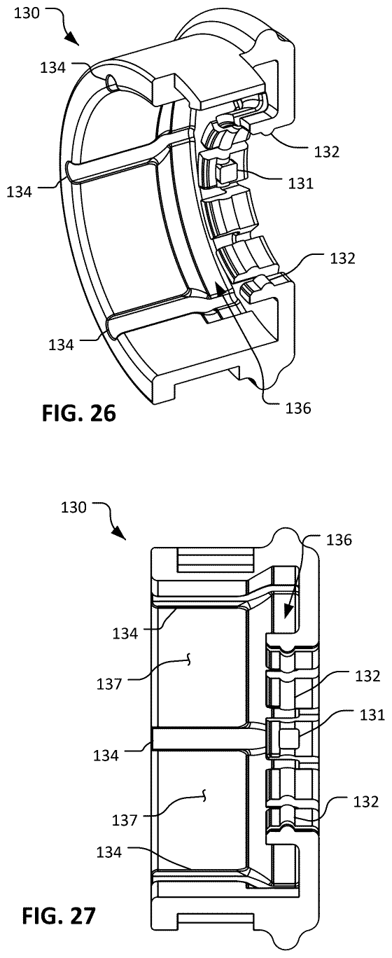

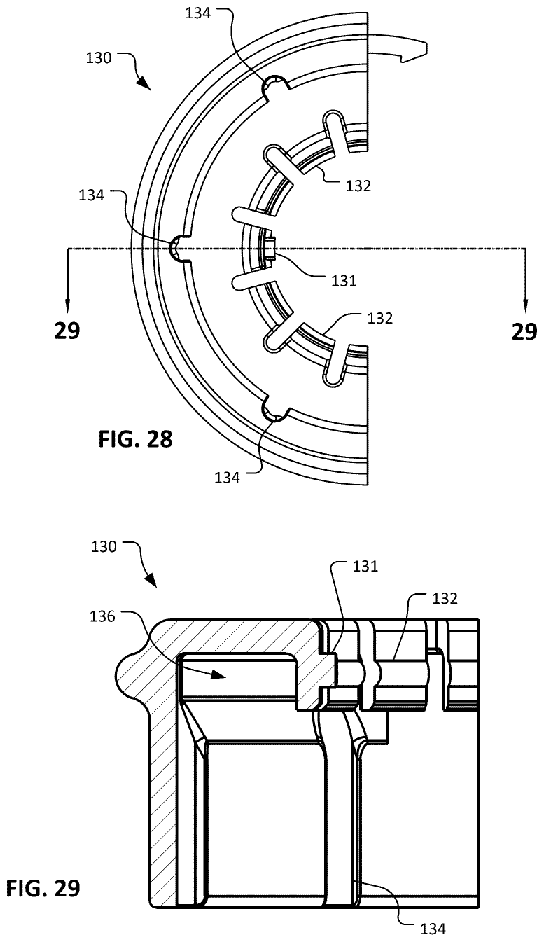

The main body 110 defines two arrangements/instances of: (i) a first longitudinal groove segment 114 and (ii) a second longitudinal groove segment 116 that are interconnected by (iii) a short circumferential groove 115. During the assembly of the fluid coupling 100, two protrusions 131 of the collar 130 (see FIGS. 26-29) are slid into the open ends of the first longitudinal groove segments 114. Then, the collar 130 is turned relative to the main body 110 so that the protrusions 131 pass along the short circumferential grooves 115. The short circumferential grooves 115 on the main body 110 include a ramp portion. Accordingly, after the protrusions 131 are moved beyond the ramp portions (into the second longitudinal groove segments 116), the ramp portions prevent the protrusions 131 from being moved backwards towards the first longitudinal groove segments 114. After the protrusions 131 have passed along the short circumferential grooves 115, the collar 130 is slid farther longitudinally (toward the sanitary fitting 113) so that the protrusions 131 pass into the second longitudinal groove segments 116 (which are the final locations of the protrusions 131). The second longitudinal groove segments 116 function as a keyway along which the protrusions 131 of the collar 130 slid as the collar 130 is moved longitudinally along the main body 110 to open and close the collet 120.

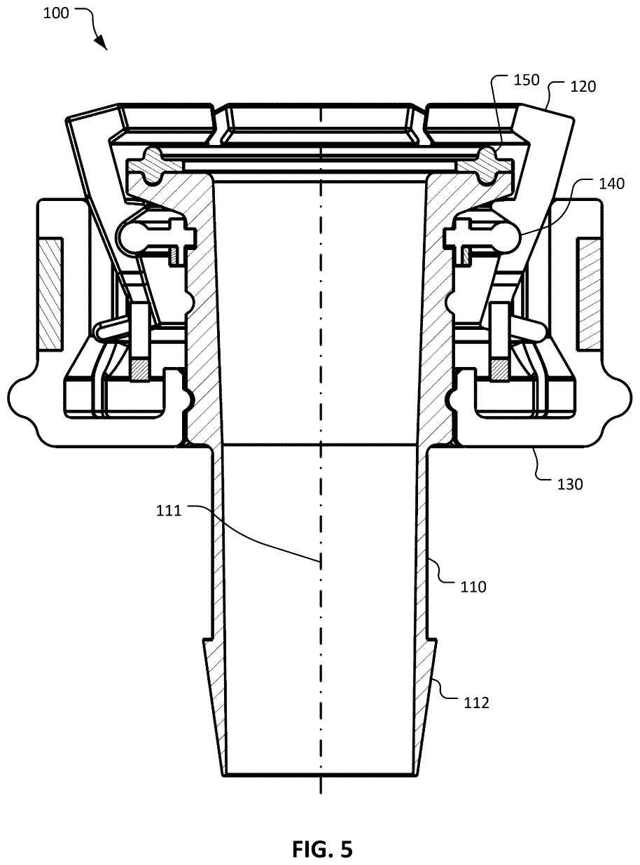

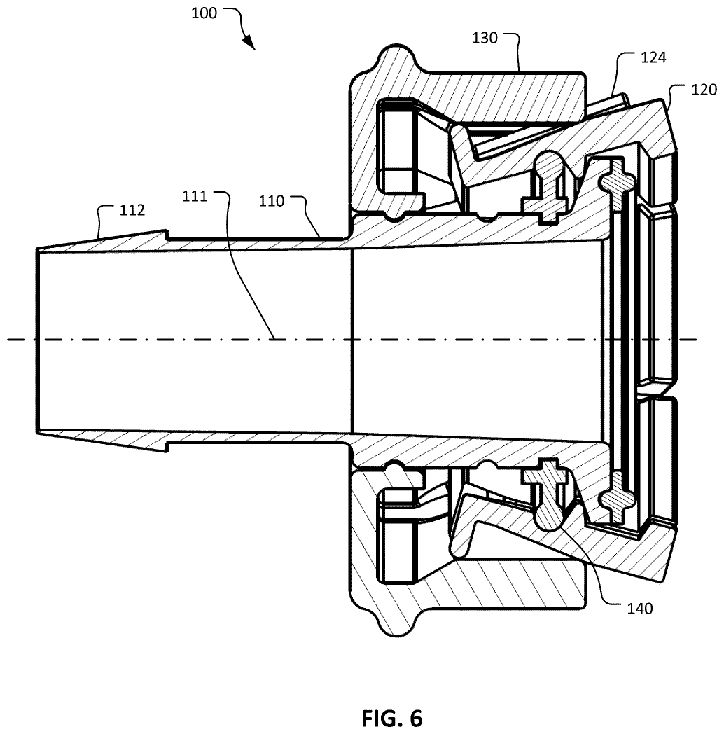

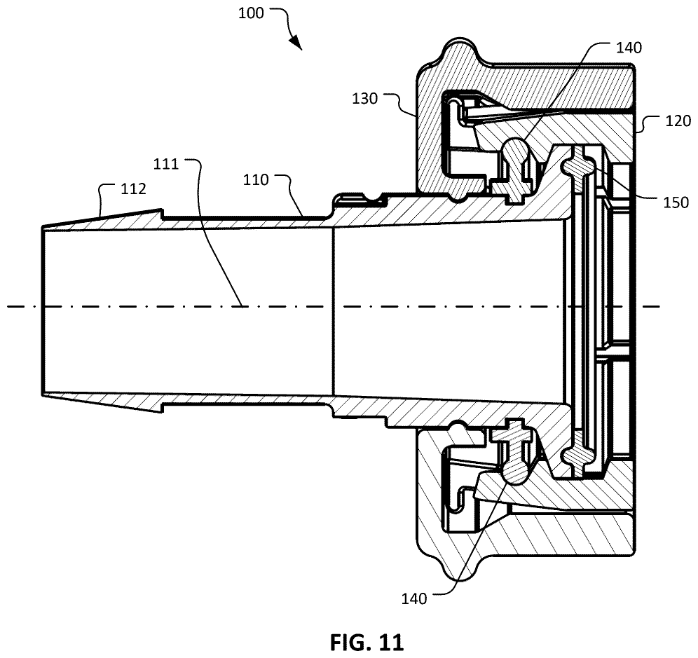

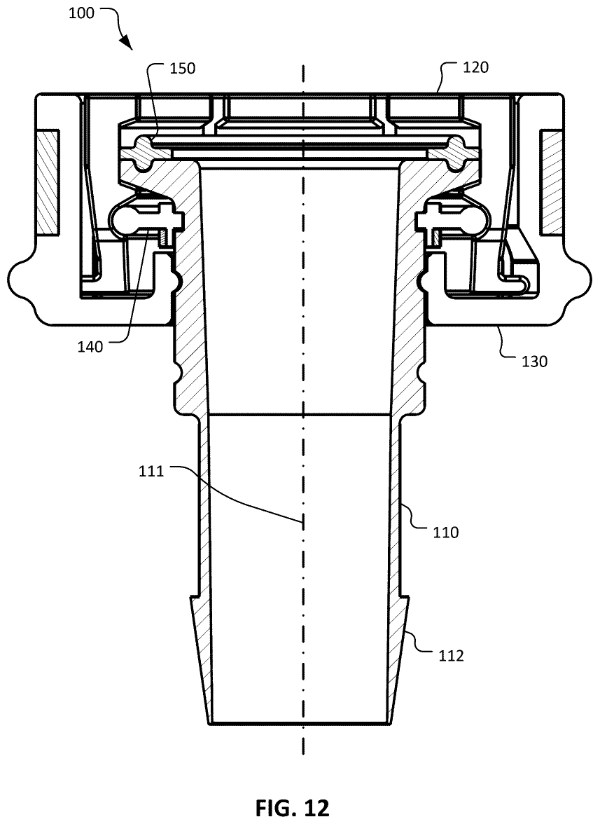

The main body 110 also defines a first annular groove 117 and a second annular groove 118. These annular grooves 117 and 118 releasably receive protuberances 132 on the inner diameter of the collar 130 (see FIGS. 26-29). The collar 130 is thereby releasably positioned/detained in the open configuration position (e.g., see FIGS. 5 and 6) and the closed configuration position (e.g., see FIGS. 11 and 12).

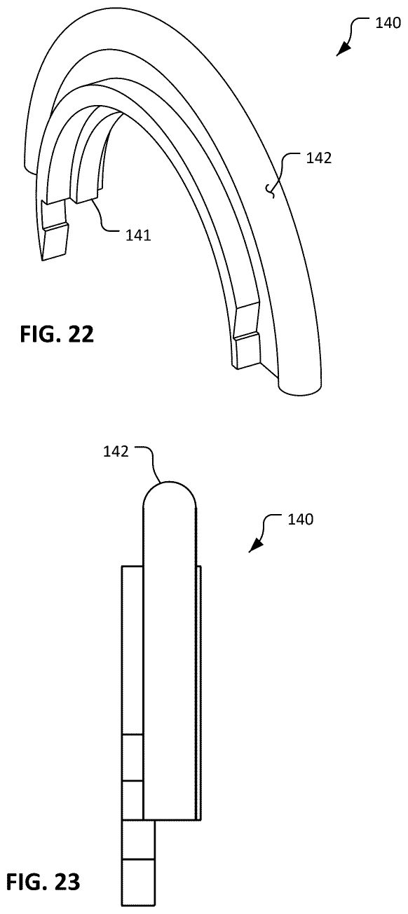

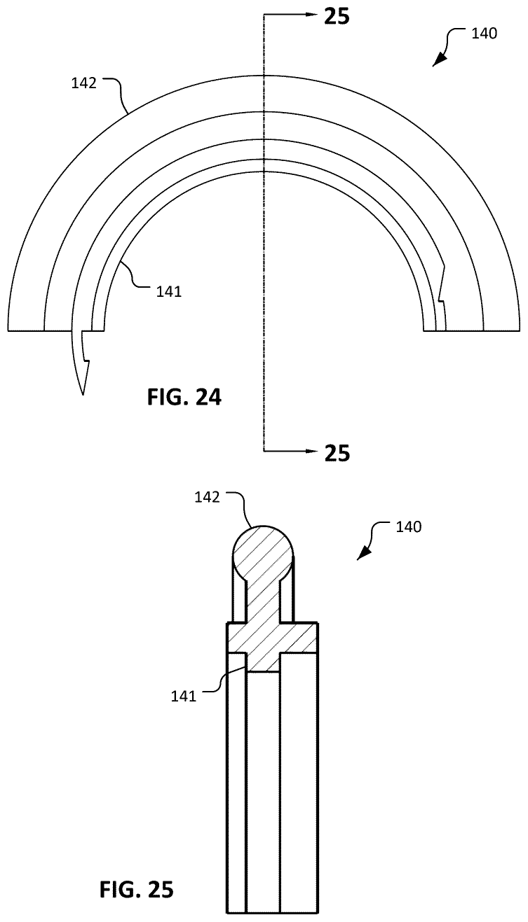

The main body 110 also defines a third annular groove 119. The third annular groove 119 receives a circumferential lip 141 of the fulcrum member 140 (see FIGS. 22-25). The engagement of the circumferential lip 141 in the third annular groove 119 locates and maintains the fulcrum member 140 in the proper position, coupled on the main body 110.

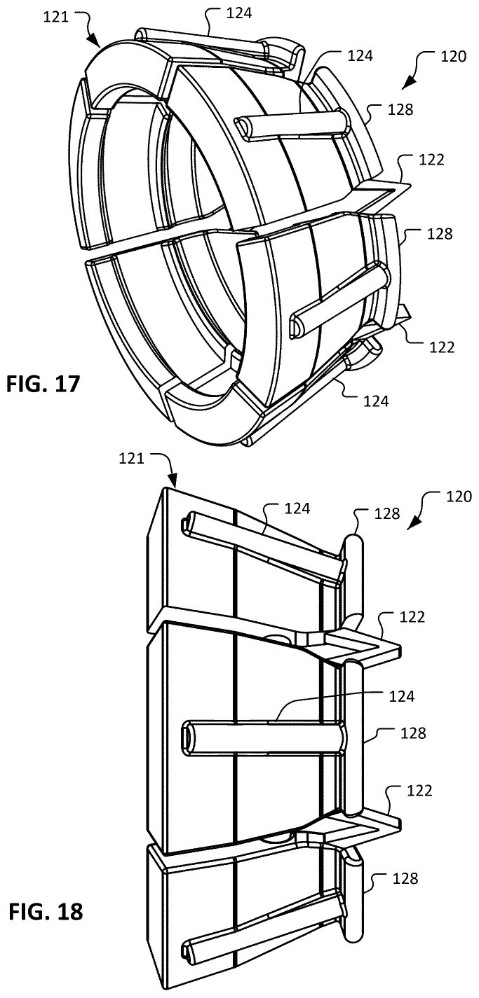

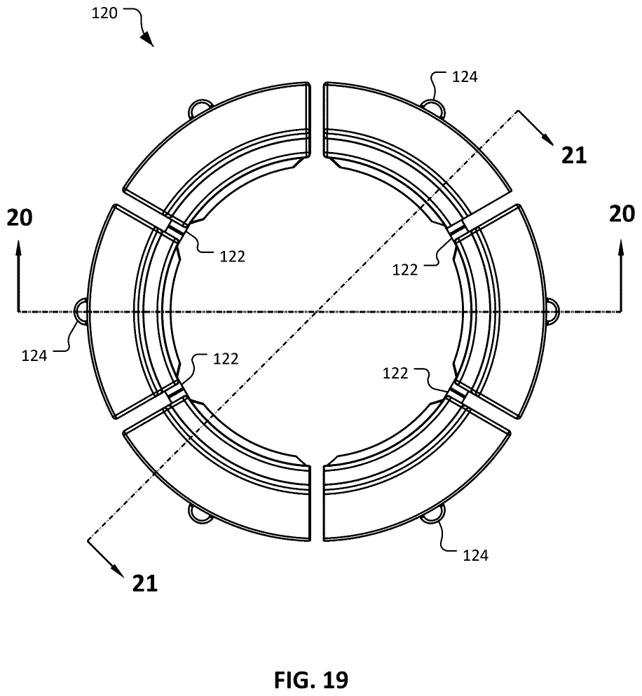

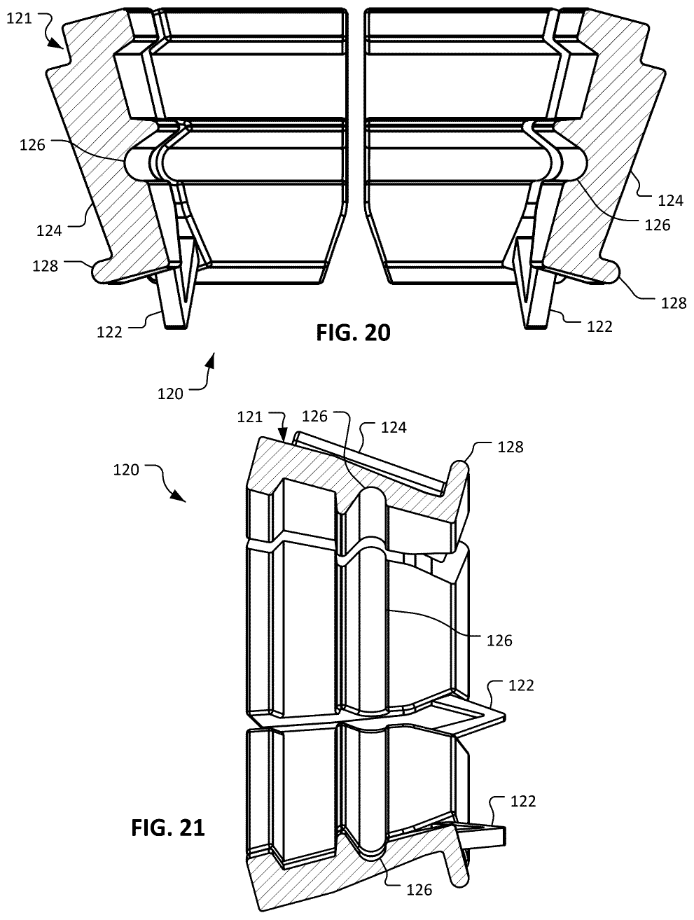

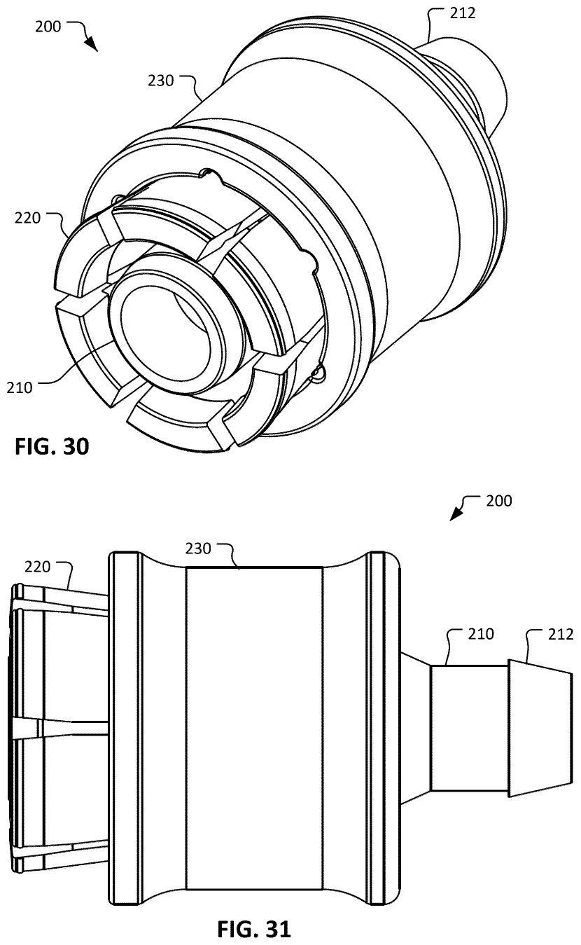

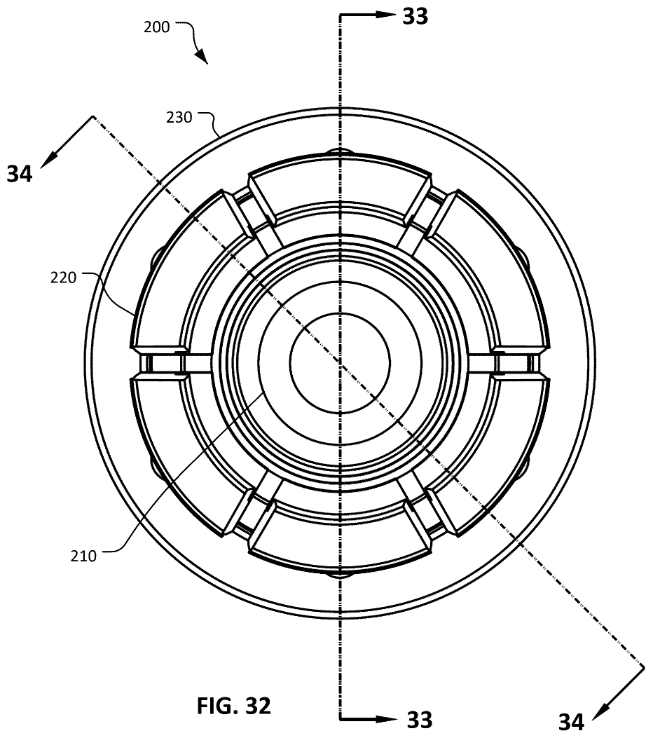

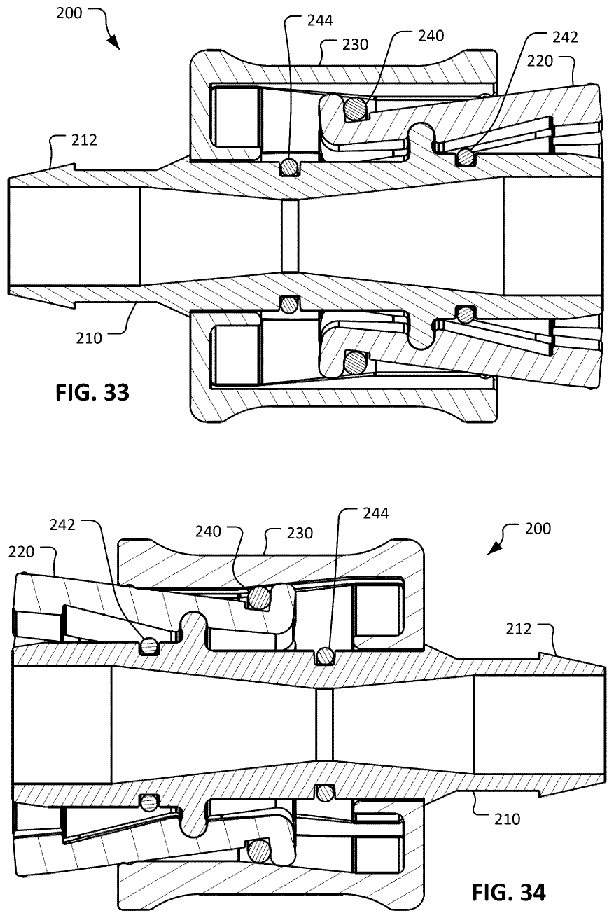

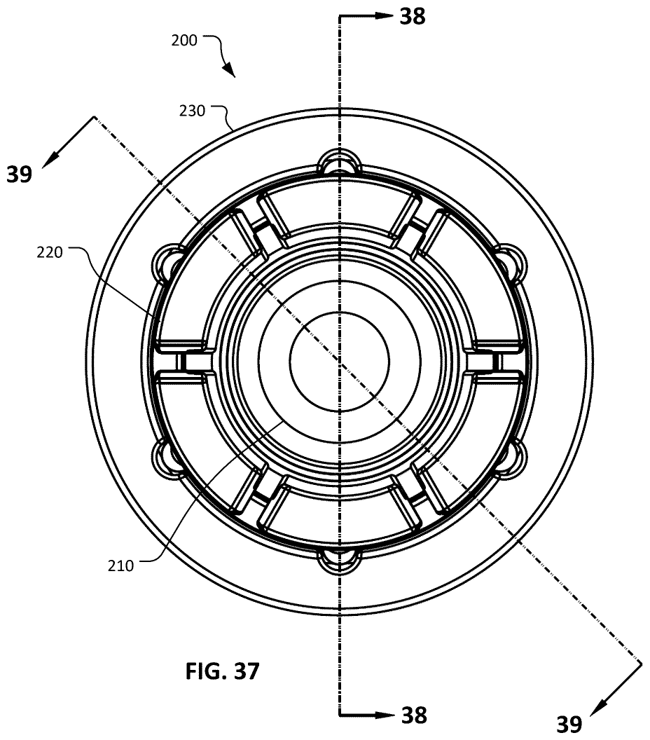

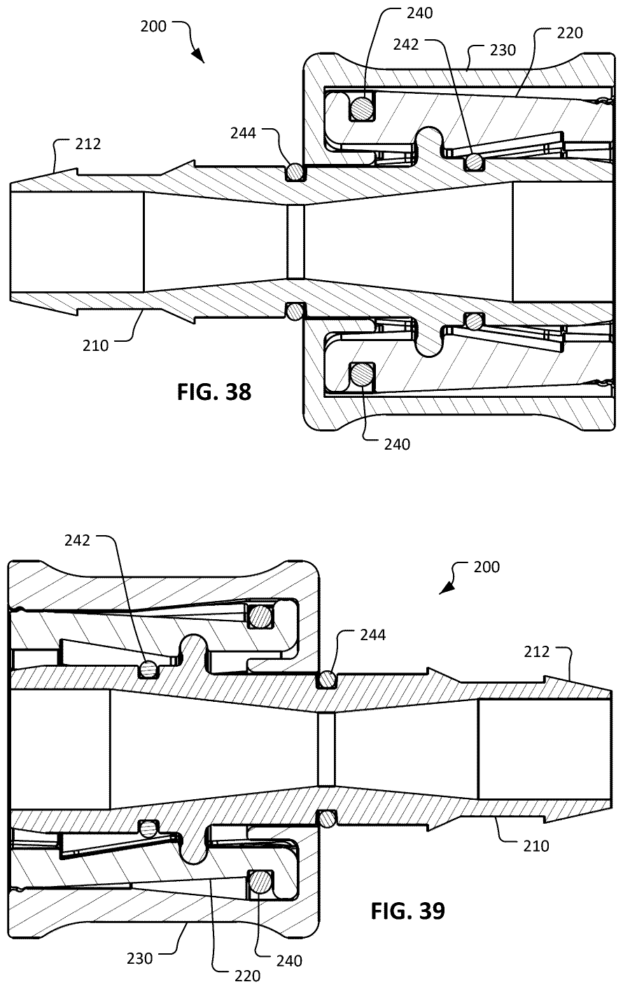

In FIGS. 17-21, the collet 120 is shown in isolation so that its features are more clearly visible. The collet 120 defines a plurality of arcuate segments. A front-end portion 121 of the collet 120 surrounds a second end of the main body 110 that is opposite of the first end of the main body 110. The front-end portion 121 of the collet 120 defines an internal space that is configured to receive the fitting of a mated coupling. The internal space can be configured to receive various types of fittings. In the depicted embodiment, the internal space of the front-end portion 121 of the collet 120 defines an internal space that is configured to receive a sanitary fitting. In other embodiments, the front-end portion 121 of the collet 120 can define an internal space that is configured to receive a barbed fitting (e.g., see fluid coupling 200 depicted in FIGS. 30-39 and described herein), and various other types of fittings.

In the depicted embodiment, the collet 120 is made up of six arcuate segments. In some embodiments, the collet 120 can be made up of a different number of arcuate segments such as, two arcuate segments, three arcuate segments, four arcuate segments, five arcuate segments, seven arcuate segments, eight arcuate segments, nine arcuate segments, ten arcuate segments, or more than ten arcuate segments.

Some, or all, of the arcuate segments can be interconnected by a living hinge 122 to group the arcuate segments together. For example, in the depicted embodiment the collet 120 includes six arcuate segments that are made up of two groups of three. That is, the collet 120 has two separate halves that each include three arcuate segments that are connected together (by two living hinges 122 interconnecting the three arcuate segments). In other embodiments, all of the arcuate segments of the collet 120 are interconnected by living hinges 122. Or, in some embodiments the six arcuate can be made up of pairs of arcuate segments that are connected (two-by-two). In some embodiments, none of the arcuate segments are interconnected (e.g., the individual arcuate segments are unattached to each other). Any combination of interconnection or non-interconnection of the arcuate segments is envisioned within the scope of this disclosure.

The collet 120 also includes one or more longitudinally extending protrusions 124. In the depicted embodiment, each arcuate segment of the collet 120 has a single corresponding longitudinally extending protrusion 124 on its outer surface. The longitudinally extending protrusions 124 are slidably disposed in corresponding longitudinally extending grooves 134 defined by the collar 130 (e.g., see FIGS. 26-29). The sliding longitudinal engagement between the longitudinally extending protrusions 124 and the longitudinally extending grooves 134 facilitates consistent registration between the arcuate segments of the collet 120 and the collar 130 as the collet 120 is reconfiguring between the open and closed configurations in response to longitudinal movements of the collar 130 along the collet 120.

A mid-body portion of the collet 120 also defines an internal circumferential annular groove 126. In the depicted embodiment, each arcuate segment of the collet 120 defines a corresponding arcuate segment portion of the internal annular groove 126.

The internal annular groove 126 receives a radiused outer surface 142 of the fulcrum member 140 (see FIGS. 22-25). The collet 120 is in contact with the fulcrum member 140 because of the engagement between the internal annular groove 126 of the collet 120 and the radiused outer surface 142 of the fulcrum member 140. In fact, the arcuate segments of the collet 120 are each longitudinally pivotable about or in relation to the fulcrum member 140 (and the rest of the fluid coupling 100) because of the pivotable engagement between the arcuate segments of the collet 120 and the fulcrum member 140. As the collar 130 is longitudinally moved to reconfigure the collet 120 between the open and closed configurations, the arcuate segments of the collet 120 longitudinally pivot about the fulcrum member 140. In that manner, the fulcrum member 140 acts as a fulcrum about which each of the arcuate segments of the collet 120 longitudinally pivot.

The rear-end portion of the collet 120 includes a circumferential annular projection 128 (projecting radially). In the depicted embodiment, each arcuate segment of the collet 120 includes a corresponding arcuate portion of the circumferential annular projection 128.

In the closed configuration of the collet 120, the circumferential annular projection 128 is positioned within an internal annular receiving space 136 defined by the collar 130 (see FIGS. 26-29).

When a user reconfigures the collet 120 from the closed configuration to the open configuration by longitudinally sliding the collar 130 toward the termination 112 of the main body 110, the circumferential annular projection 128 is moved out of the internal annular receiving space 136 defined by the collar 130 and then the smaller inner diameter region 137 (see FIG. 27) of the collar 130 presses the circumferential annular projection 128 radially inward to radially collapse the rear-end portion of the collet 120. The radially inward movement of the rear-end portion of the collet 120 where the circumferential annular projection 128 is located causes the arcuate segments of the collet 120 to pivot about the fulcrum member 140. In result, the front-end portion of the collet 120 moves radially outward to open the front-end portion of the collet 120. In this open configuration, a fitting of a mated fluid coupling can be released and removed from engagement with the fluid coupling 100, or the fitting of another fluid coupling to be coupled with the fluid coupling 100 can be received by the front-end portion of the collet 120.

When a user reconfigures the collet 120 from the open configuration to the closed configuration by longitudinally sliding the collar 130 toward the front end of the collet 120, the inner diameter of the front-end of the collar 130 pushes the front-end portions of the arcuate segments of the collet 120 radially inward to potentially clamp on a fitting of a mated fluid coupling. The radially inward force from the collar 130 on the front-end portions of the arcuate segments of the collet 120 causes the arcuate segments of the collet 120 to pivot about the fulcrum member 140. In result, the circumferential annular projection 128 at the rear-end portion of the collet 120 moves radially outward and into the clearance provided by the internal annular receiving space 136 defined by the collar 130.

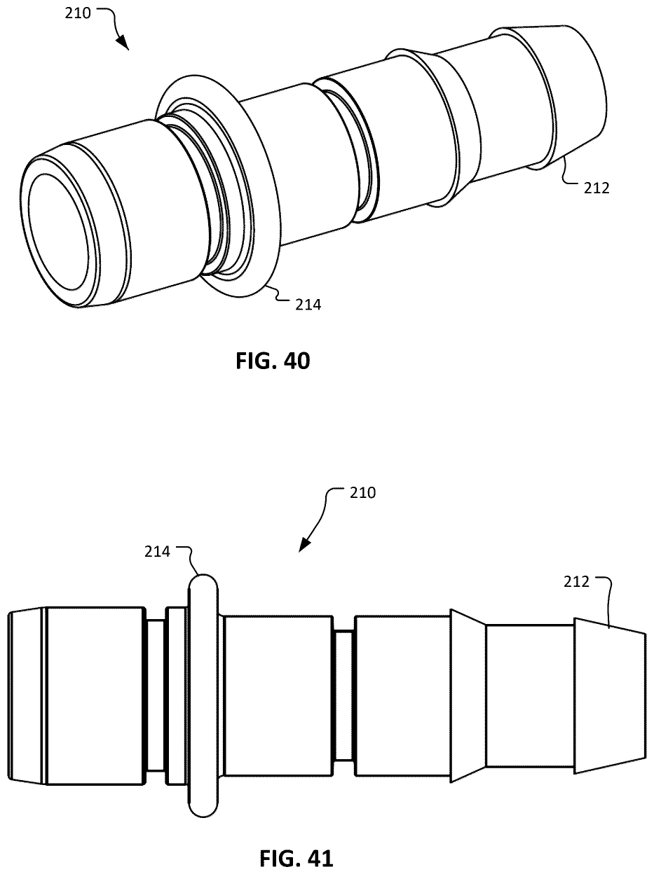

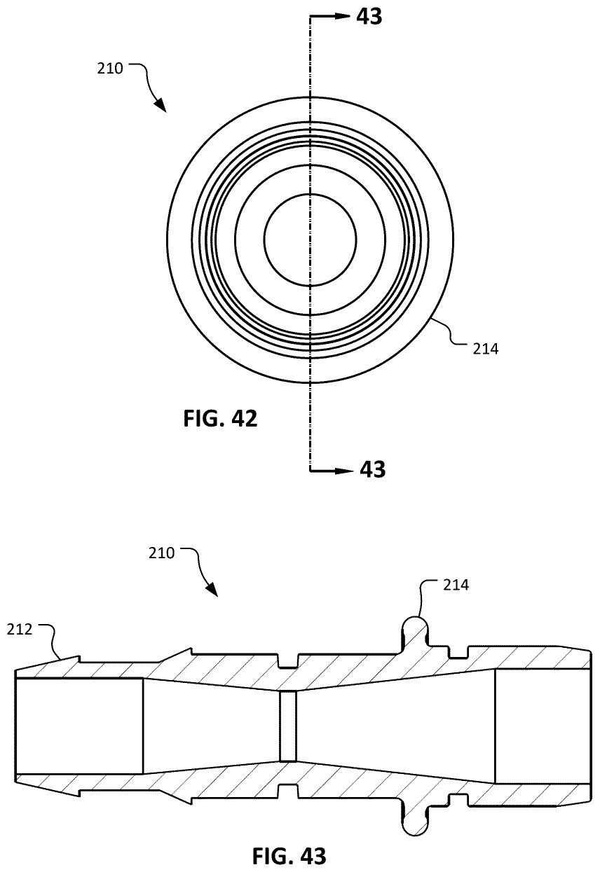

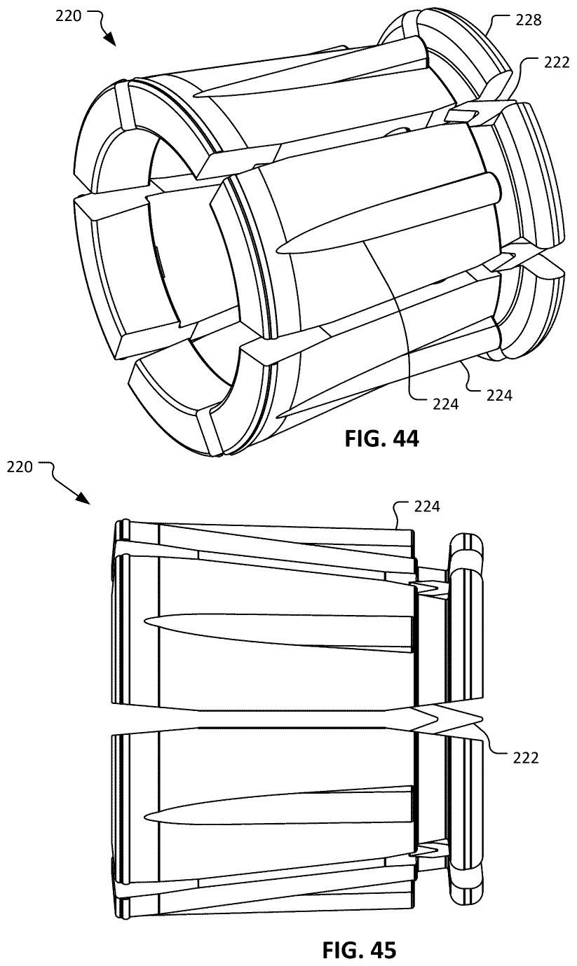

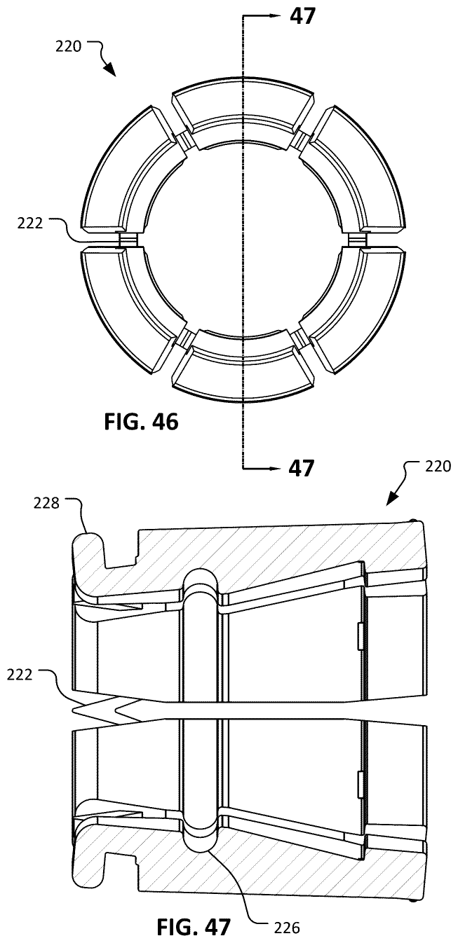

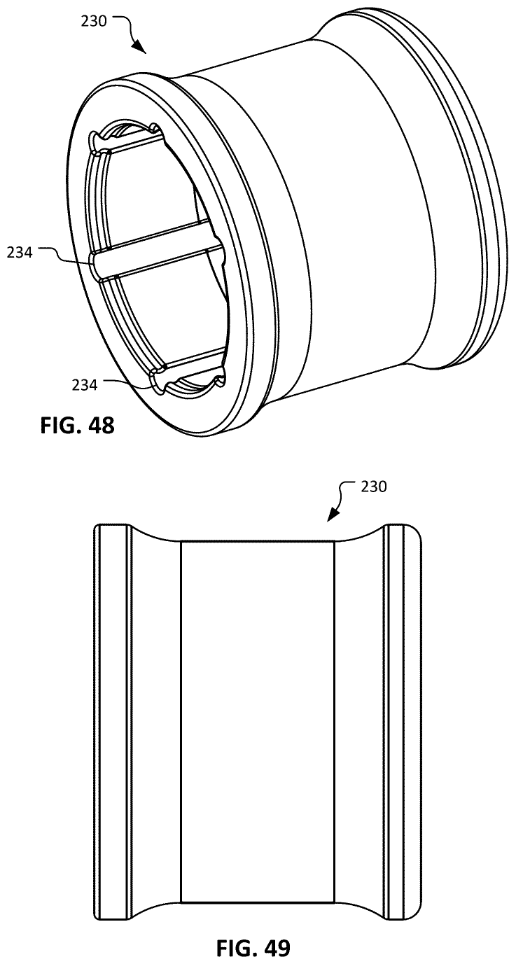

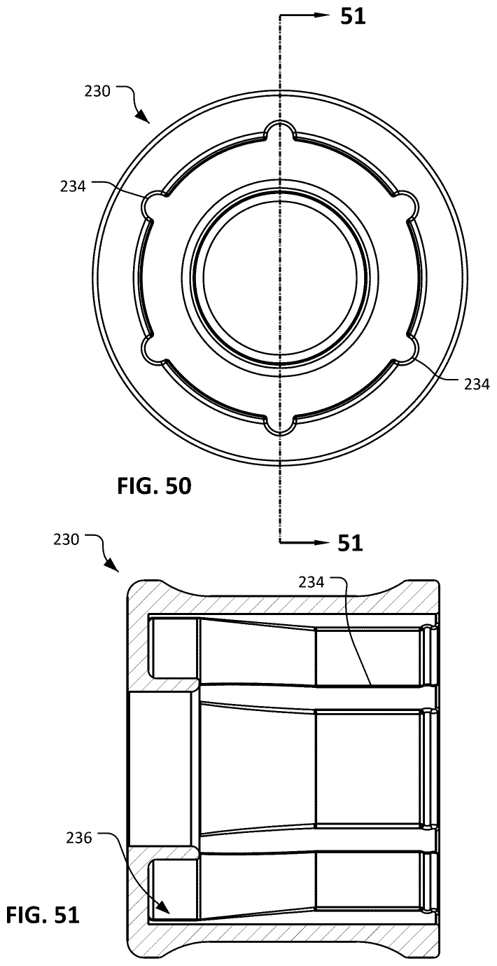

FIGS. 30-51 show another example fluid coupling in an assembled form (FIGS. 30-39) and in component form (FIGS. 40-51). This fluid coupling 200 includes many of the same type of components and functionality as the fluid coupling 100 described in detail above. Accordingly, the fluid coupling 200 need not be explained in as much detail as the fluid coupling 100.

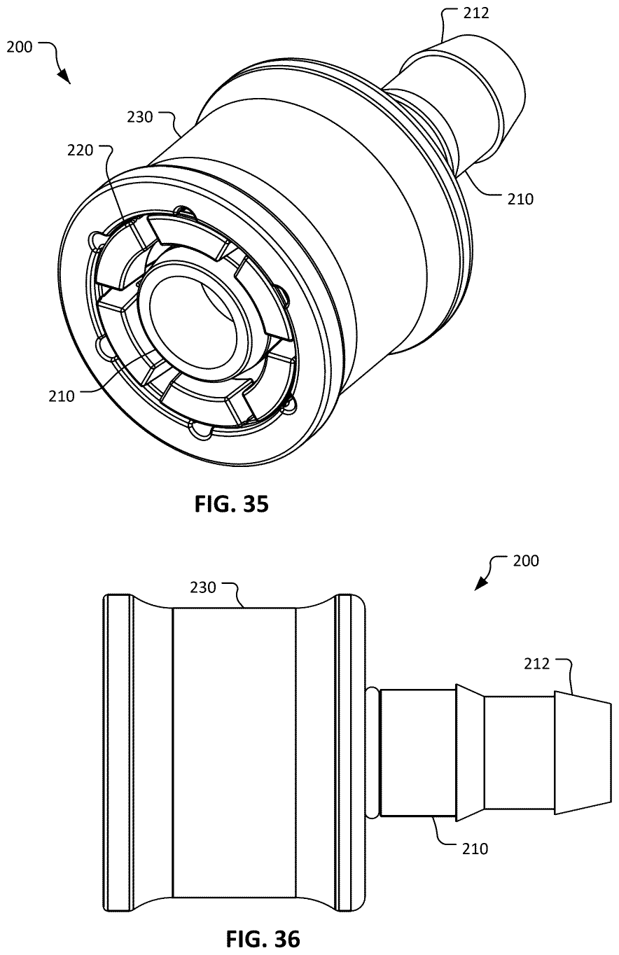

The fluid coupling 200 is shown in its open configuration in FIGS. 30-34. The fluid coupling 200 is shown in its closed configuration in FIGS. 35-39.

The fluid coupling 200 includes a main body 210, a collet 220, a collar 130, and a garter spring 240.

While the fluid coupling 200 has many similarities with the fluid coupling 100, the fluid coupling 200 is different from the fluid coupling 100 in the following ways.

In the depicted example configuration of the fluid coupling 200, the open internal area defined by the front-end portion of the collet 220 is sized and shaped (i.e., configured) to receive a barbed fitting of a mated or mate-able fluid coupling.

The fluid coupling 200 includes the garter spring 240 that surrounds the rear-end portion of the collet 220. The garter spring 240 (which can be a circumferential coil spring, an elastomeric O-ring, etc.) serves to hold together the arcuate segments of the collet 220 during the assembly process of the fluid coupling 200. The garter spring 240 can also assist with the opening of the front-end portion of the collet 220 when the collar 230 is slid toward the termination 212 of the main body 210.

As described above, the fulcrum member 140 of the fluid coupling 100 is a two-piece construction that is separate from the main body 110. In contrast, the main body 210 of the fluid coupling 200 includes an integral fulcrum 214 (see FIGS. 40-43)

As described above, the collar 130 of the fluid coupling 100 is a two-piece construction. In contrast, the collar 230 of the fluid coupling 200 is a single construct.

The fluid coupling 200 also includes a seal member 242. The seal member 242 is partially disposed within an annular groove defined by the main body 210. The seal member 242 is arranged to seal against the inner diameter of a mated fluid connection such as, but not limited to, a barbed fluid connection.

The fluid coupling also includes a member 244. The member 244 is partially disposed within an annular groove defined by the main body 21. In some embodiments, the member 244 is an elastomeric O-ring. The member 244 can be used to provide resistance to longitudinal movement of the collar 230.

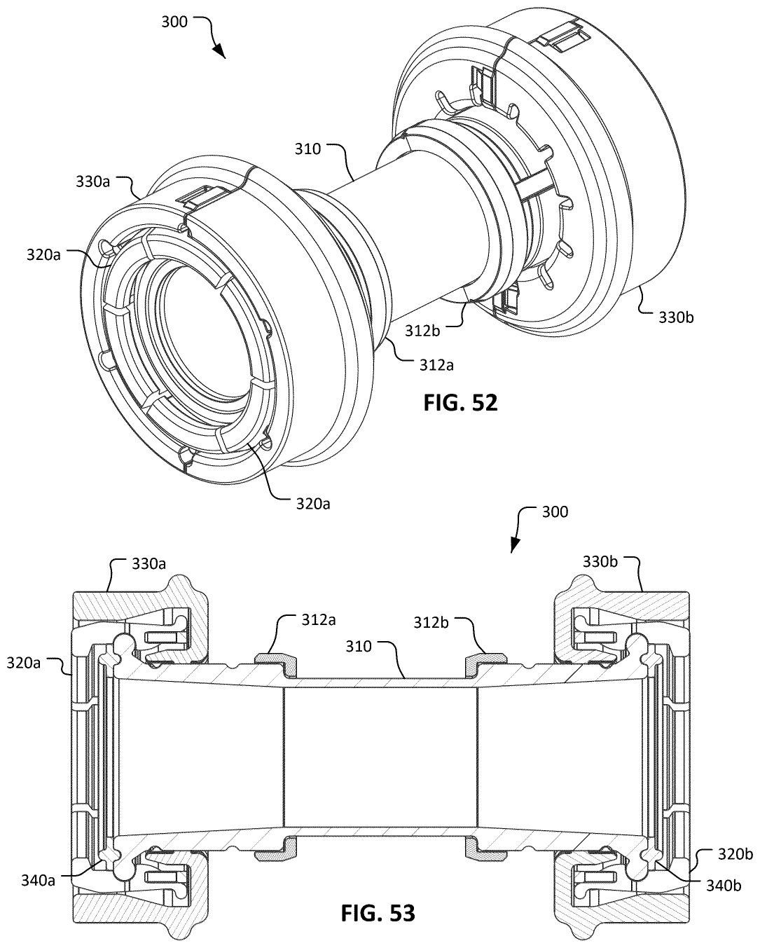

Referring to FIGS. 52 and 53, a union coupling 300 can be constructed using any of the collet-style of fluid connections (e.g., for sanitary fittings, threaded fittings, barbed fittings, compression fittings, etc.) as described herein. Both end connections of the union coupling 300 can be configured with the same style of collet-style of fluid connection, or the ends of the union coupling 300 can be configured with different styles of collet-style of fluid connections. The union coupling 300 can easily couple together two fluid handling conduits or devices by serving as a connecting member therebetween.

A first end of the depicted union coupling 300 includes a first collet 320a, a first collar 330a, and a first seal 340a. The first end is configured to releasably couple with a sanitary fluid coupling, but the first end can alternatively be configured to releasably couple with a barbed fitting, threaded fitting, or another type of fitting.

A second end of the depicted union coupling 300 includes a second collet 320b, a second collar 330b, and a second seal 340b. The second end is configured to releasably couple with a sanitary fluid coupling, but the second end can alternatively be configured to releasably couple with a barbed fitting, threaded fitting, or another type of fitting.

The union coupling 300 includes a main body 310. The main body 310 includes fulcrums on which the segments of the collets 320a and 320b pivot, and defines an open central passageway that extends longitudinally between the two collet-style ends of the union coupling 300. In the depicted embodiment, a first retaining collar 312a and a second retaining collar 312b (that are both on the main body 310) can serve to limit the longitudinal travel of the retaining collars 330a and 330b.

The retaining collar 312a and 312b are each constructed in two-pieces (e.g., two halves) so they can be assembled on/over the main body 310 after the assembly of the collet-style ends. That is, prior to the installation of the retaining collars 312a and 312b on the main body 310, the collet collars 330a and 330b can be slid farther back away from the ends, thereby allowing for efficient assembly of the collets 320a and 320b. Once the components of the collets 320a and 320b are in place, the collet collars 330a and 330b can be slid toward the ends, and the retaining collars 312a and 312b are then installed on the main body 310 in their illustrated positions where they limit rearward movement of the collet collars 330a and 330b.

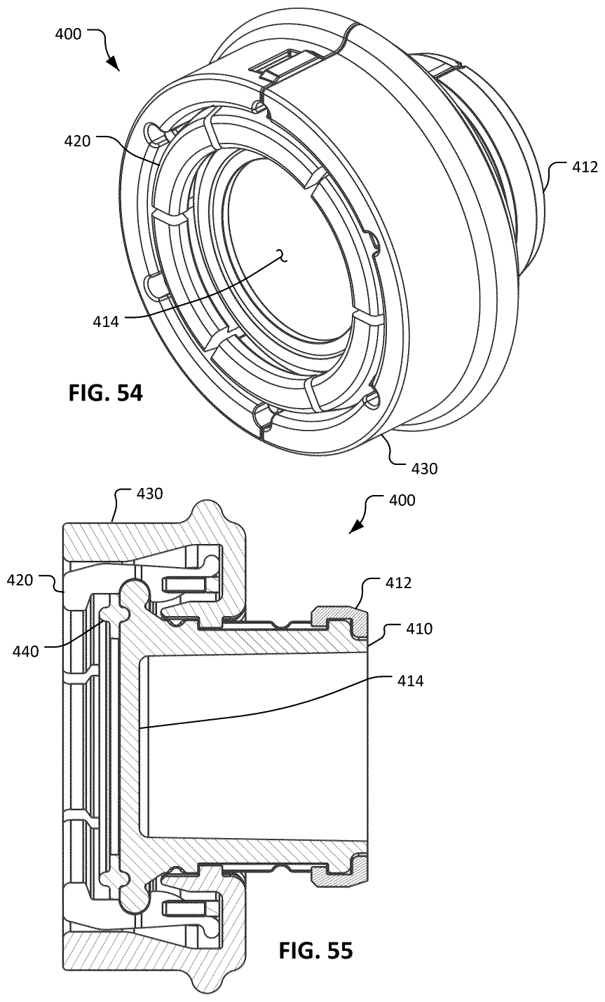

Referring to FIGS. 54 and 55, a cap coupling 400 can be constructed using any of the collet-style of fluid connections (e.g., for sanitary fittings, barbed fittings, threaded fittings, etc.) as described herein. The cap coupling 400 can easily couple with a fluid handling conduit or device to block fluid flow.

The depicted cap coupling 400 includes a collet 420, a collar 430, and a seal 440. The cap coupling 400 is configured to releasably couple with a sanitary fluid coupling, but the end can alternatively be configured to releasably couple with a barbed fitting, threaded fitting, or another type of fitting.

The cap coupling 400 includes a main body 410 and a retaining collar 412 coupled thereto. The main body 410 includes fulcrum and a blank end 414. The blank end 414 blocks fluid flow through the cap coupling 400.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

What is claimed is:

1. A fluid coupling device comprising:
a main body defining a fluid passageway extending along a longitudinal axis between a first end and a second end;
a collet comprising a plurality of arcuate segments, a front-end portion of the collet surrounding the second end of the main body and defining an open internal area shaped to receive a termination of a fluid handling component to be mated with the second end of the main body, wherein each arcuate segment is pivotable in relation to the main body to reconfigure the collet between: (i) a closed configuration in which the front-end portion of the collet is arranged to clamp onto the termination of the fluid handling component mated with the second end of the main body and (ii) an open configuration in which the front-end portion of the collet is radially expanded in comparison to the closed configuration; and
a collar surrounding the main body and at least a portion of the collet, the collar being longitudinally slidable along the main body between a first position that allows the collet to be in the open configuration and a second position that forces the collet to be in the closed configuration.

2. The fluid coupling device of claim 1, wherein a rear-end portion of the collet radially contracts when the collet reconfigures from the closed configuration to the open configuration.

3. The fluid coupling device of claim 1, wherein a midbody portion of the collet is in contact with a fulcrum about which each arcuate segment is pivotable.

4. The fluid coupling device of claim 3, wherein the main body comprises the fulcrum, or wherein the fulcrum is coupled to the main body.

5. The fluid coupling device of claim 1, further comprising a garter spring or an elastic member surrounding a rear-end portion of the collet.

6. The fluid coupling device of claim 1, wherein the open internal area shaped to receive the termination of the fluid handling component is shaped to receive a barbed end fitting, and wherein the fluid coupling device further comprises an annular seal member arranged in an annular groove defined by the main body at a location in which the annular seal member will seal against an inner diameter of the barbed end fitting.

7. The fluid coupling device of claim 1, wherein the open internal area shaped to receive the termination of the fluid handling component is shaped to receive a sanitary end fitting or a threaded fitting.

8. The fluid coupling device of claim 1, wherein the collet further comprises one or more living hinges, wherein each living hinge interconnects two adjacent arcuate segments of the plurality of arcuate segments.

9. The fluid coupling device of claim 1, wherein the collar comprises two identical half portions that are configured to snap together to form the collar.

10. The fluid coupling device of claim 1, wherein the collar defines a plurality of longitudinally extending grooves in which longitudinally extending protrusions of the plurality of arcuate segments are slidably disposed.

11. A fluid coupling device comprising:
a main body defining a fluid passageway extending along a longitudinal axis between a first end and a second end;
a collet comprising a plurality of arcuate segments; and
a collar surrounding the main body and at least a portion of the collet, the collar being longitudinally slidable along the main body between: (i) a first position that allows the collet to radially expand to an open configuration to receive a termination of a fluid handling device to be mated with the second end of the main body and (ii) a second position that forces the collet to a closed configuration in which the collet clamps onto the termination of the fluid handling device to be mated with the second end of the main body.

12. The fluid coupling device of claim 11, wherein the collet defines an open internal area shaped to receive the termination of the fluid handling component to be mated with the second end of the main body.

13. The fluid coupling device of claim 12, wherein the open internal area shaped to receive the termination of the fluid handling device is shaped to receive a barbed end fitting.

14. The fluid coupling device of claim 12, wherein the open internal area shaped to receive the termination of the fluid handling device is shaped to receive a sanitary end fitting or a threaded fitting.

15. The fluid coupling device of claim 11, wherein a midbody portion of each arcuate segment is pivotable in relation to the main body about a fulcrum to reconfigure the collet between the open configuration and the closed configuration.

16. The fluid coupling device of claim 15, wherein the main body comprises the fulcrum, or wherein the fulcrum is coupled to the main body.

17. The fluid coupling device of claim 11, wherein each arcuate segment is uncoupled from any other arcuate segment.

18. The fluid coupling device of claim 11, further comprising a garter spring or an elastic member surrounding a rear-end portion of the collet.

19. The fluid coupling device of claim 11, wherein the collar defines a plurality of longitudinally extending grooves in which longitudinally extending protrusions of the plurality of arcuate segments are slidably disposed.

20. The fluid coupling device of claim 11, wherein the collet defines a plurality of longitudinally extending grooves in which longitudinally extending protrusions of the collar are slidably disposed.

21. The fluid coupling device of claim 11, wherein the collar is configured to contact rear ends of the arcuate segments to radially expand the collet to the open configuration when the collar is in the first position.

22. The fluid coupling device of claim 11, wherein the collet and the collar are positioned at the first end of the main body, and further comprising a second collet and a second collar positioned at the second end of the main body.

23. The fluid coupling device of claim 22, further comprising:
a first two-piece retaining collar on the main body and positioned to define the first position of the collar; and
a second two-piece retaining collar on the main body and positioned to define a first position of the second collar.

24. The fluid coupling device of claim 11, wherein the first end of the main body includes a blank end arranged to block fluid flow through the fluid coupling device.
